(19) United States
(12) Patent Application Publication
(10) Pub. No.: US 2018/0158017 A1
(43) Pub. Date: Jun. 7, 2018

(54) PRODUCT IDENTIFICATION AND TRACKING

(71) Applicant: Wal-Mart Stores, Inc., Bentonville, AR (US)

(72) Inventors: Nicholaus A. Jones, Fayetteville, AR (US); Matthew A. Jones, Bentonville, AR (US)

(21) Appl. No.: 15/824,961

(22) Filed: Nov. 28, 2017

Related U.S. Application Data
(60) Provisional application No. 62/429,319, filed on Dec. 2, 2016.

(51) Int. Cl. G06Q 10/08; G01G 19/414

(52) U.S. Cl. CPC G06Q 10/087; G01G 19/4144

(57) ABSTRACT

In some embodiments, apparatuses and methods are provided herein useful to track inventory within a store. Stocking procedure and/or inventory analysis can be utilized on delivery vehicles to determine an unloading order for products being unloaded at a retail location. The products can then be identified and tracked after unloading until they are needed to restock product displays at the front of the store. In several embodiments, store layout information can be compared to a location of the products during restocking to determine whether the products are being restocked in a correct location within the store.

### CROSS-REFERENCE TO RELATED APPLICATION

This application claims the benefit of U.S. Provisional Application No. 62/429,319, filed Dec. 2, 2016, which is incorporated by reference in its entirety herein.

### TECHNICAL FIELD

This invention relates generally to inventory tracking and, more particularly, to inventory tracking of products between delivery and stocking.

### BACKGROUND

Inventory tracking can be important for retail locations. For example, inventory tracking can be used to determine an accurate stock count and, accordingly, can help a retail location determine when to order additional units of a product. In some instances, products are delivered to a store, unloaded in a back area of the store where the products are held until needed, and then transferred to the front of the store to restock. Issues in inventory tracking, such as misplacement of products in the back of a store or stocking the products incorrectly in the front of a store, can result in inaccurate stock counts.

### BRIEF DESCRIPTION OF THE DRAWINGS

Disclosed herein are embodiments of systems, apparatuses and methods pertaining identifying and tracking products from unloading to stocking at the front of a store. This description includes drawings, wherein:

FIG. 1 is a perspective view of a product storage structure with an array of sensors mounted thereto in accordance with some embodiments;

FIG. 2 is diagrammatic view of interacting components of the system in accordance with several embodiments;

FIG. 3 is top diagrammatic view of a back of a store in accordance with some embodiments; and

FIG. 4 is a flowchart in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to track inventory within a store. Stocking procedure and/or inventory analysis can be utilized on delivery vehicles to determine an unloading order for products being unloaded at a retail location. The products can then be identified and tracked after unloading until they are needed to restock product displays at the front of the store. In several embodiments, store layout information can be compared to a location of the products during restocking to determine whether the products are being restocked in a correct location within the store. As such, the system can accurately monitor the products and maintain an accurate stock count.

More specifically, a product storage structure can be equipped with an array of sensors to sense products being placed thereon and can receive the product identification from the unloading order. Thereafter, the structure can associate a portion thereof with the identified product to thereby maintain a location for the product. If desired, the sensors can determine other properties of the product, such as weight, dimensions, or the like.

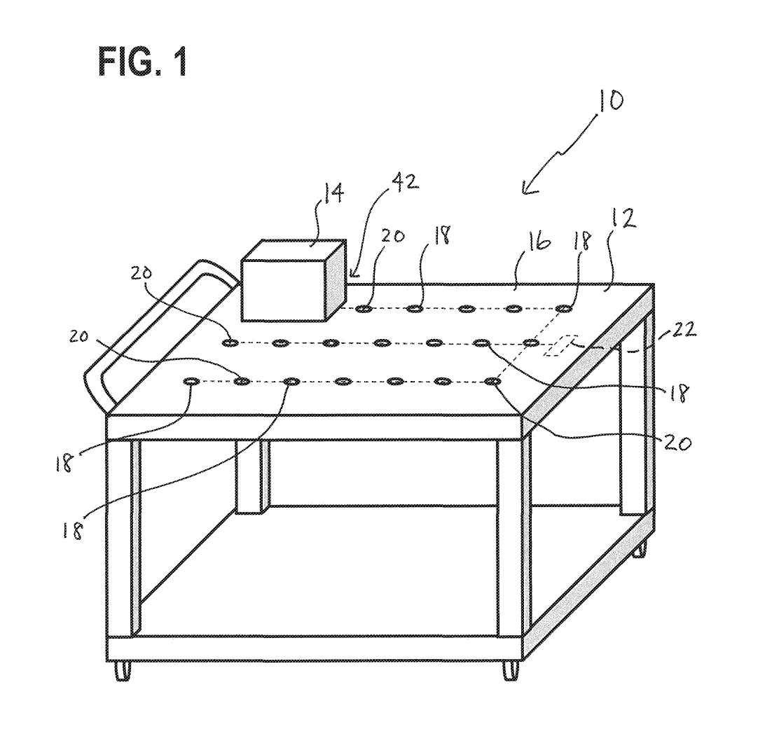

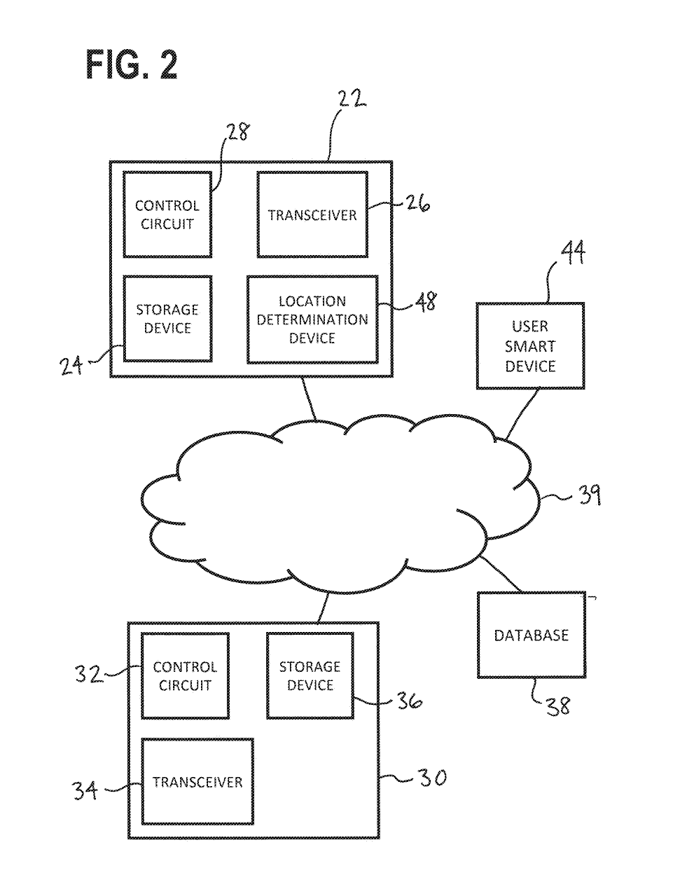

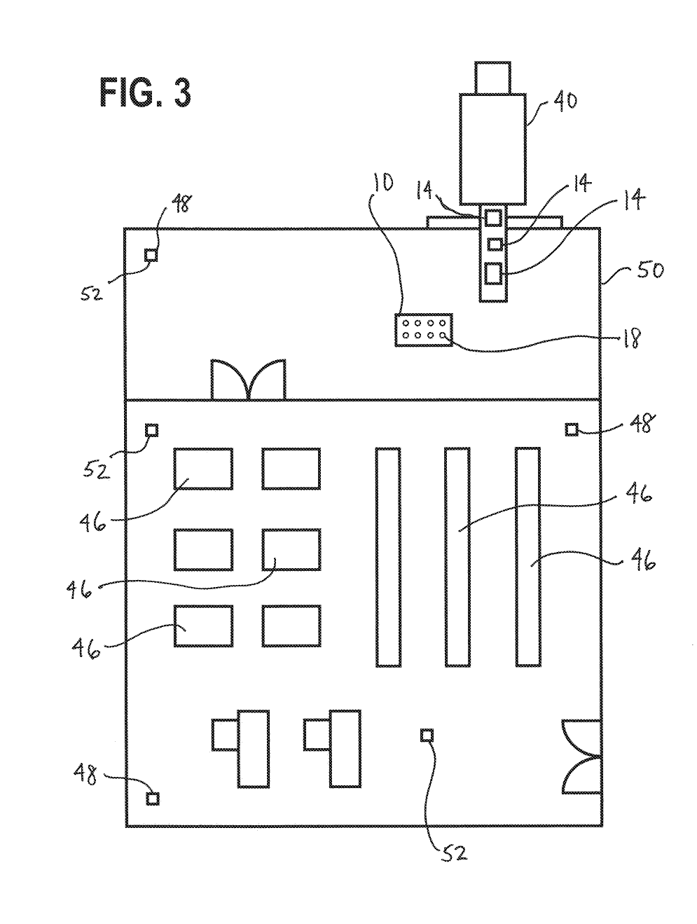

Details of the system are shown in FIGS. 1-4. As shown in FIG. 1, a product storage structure 10 includes an upper wall 12 configured to receive products 14 on an upper surface 16 thereof. The products 14 will be understood to include any desired type of packaging, individual or multiple products, and so forth. Similarly, the storage structure 10 can be any suitable structure. For example, the storage structure 10 can be a pallet or panel as shown and transported on a cart, by hand, or by other devices. By another approach, the storage structure 10 can be incorporated into a cart for easy transportation. By further approaches, the storage structure 10 can have multiple walls 12, such as for shelving, and the like.

The storage structure 10 further includes an array of sensors 18 mounted thereto and distributed across the upper wall 12 to detect a product 14 placed thereon. The sensors 18 can be embedded within the upper wall 12, mounted to the upper surface 16 of the upper wall 12, or the like. By some approaches, the sensors 18 each include an actuator 20 that projects above the upper surface 16 of the upper wall 12 to be actuated when a product 14 is placed thereon. By other approaches, the sensors 18 can be light-based or laser sensors configured to actuate when an object blocks the sensor or interrupts a beam thereof. Preferably, the array of the sensors 18 is sized so that the sensors 18 are spaced apart from one another across the upper wall 12 such that when a product 14 is placed thereon at any desired location on the upper wall 12, the product 14 actuates at least one of the sensors 18.

In some embodiments, the sensors 18 can be weight sensors configured to determine, alone or in combination, a weight of a product 14 placed thereon. Weight sensors 18 can advantageously provide additional information about the product 14 to the system, as will be described in more detail below.

The sensors 18 can be a portion of an electronic assembly 22 of the storage structure 10, which can include a storage device 24, a transceiver 26, and a control circuit 28 controlling operation thereof. So configured, the control circuit 28 can monitor operation of the sensors 18 and receive readings therefrom. By one approach, the control circuit 28 can store the readings on the storage device 24. By another approach, the control circuit 28 can send the readings to a central system 30, which can include a control circuit 32, transceiver 34, and storage device 36, over any suitable communication network or combination of networks 39, such as WiFi, radio, Bluetooth, and so forth.

The term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 28, 32 may be configured (for example, by using corresponding programming stored in a memory as will be well understood by those skilled in the art) to carry out one or more of the steps, actions, and/or functions described herein.

Organizations often follow protocols or guidelines when stocking delivery vehicles, such as where certain products should be stored, an order for products to be loaded, and so forth. Accordingly, while a delivery vehicle 38 is being unloaded, the protocols or guidelines can be utilized to determine an identification of sequentially-unloaded products 14, or a general identification of the type of sequentially-unloaded products 14. By one approach, when the protocols are closely followed, the order and identity of products 14 being unloaded can be directly deduced. By another approach, the general type of products, such as a product category, e.g., produce, home goods, toiletries, etc., department, stock location within the store, or the like, can be deduced. Alternatively, or in addition thereto, the storage structure 10 can be dedicated to or associated with the general type of products. Accordingly, as a user unloads products 14 from the delivery vehicle 38, the user can select a storage structure 10 with the appropriate associated type of products and place the product 14 thereon. As such, the control circuit 28, 32 can deduce that the product 14 placed on the storage structure 10 is of the associated type of products.

More specifically, the control circuit 28, 32 can access or receive shipping information for a particular delivery vehicle 38 that includes product identification information and packing information and utilize the shipping information to determine an unloading order of the products 14. The shipping information can be stored on a remote storage device 40, such as a database or server, or the local storage device 24, 36, if desired. As products 14 are unloaded and placed on the storage structure 10, the sensors 18 upon which the products 14 are placed will transmit a reading to the control circuit 28. As each product 14 is placed and registered by one or more of the sensors 18, the control circuit 28 can then identify the product 14 using the unloading order and associate a location 42, identified by the one or more sensors 18, with the identified product 14. Thereafter, the product 14 and its associated location 42 can be stored on one or more of the storage devices 24, 36, 40. Further, with the approach discussed above where the storage structure 10 is dedicated to a general type of products, the control circuit 28, 32 can utilize this additional information, in combination with the time the product 14 was unloaded from the delivery vehicle 38, to determine an identity of the product 14. Accordingly, even if products 14 of different general types are loaded adjacent to one another on the delivery vehicle 38, the control circuits 28, 32 can quickly determine the differences.

As discussed above, in some embodiments, the sensors 18 can be weight sensors. Accordingly, when products 14 are placed on the storage structure 10, the sensors 18 can determine a first weight of each product 14. The control circuit 28 can further store the first weight in one or more of the storage devices 24, 36, 40 and associate the first weight with the product 14. After the storage structure 10 has been fully loaded with products 14, the control circuit 28 thereof can monitor the location 42 and, if desired, weight of the products 14 stocked thereon.

By a further approach, the shipping information can include dimensions and specifications for the products 14. So configured, the weight read by the sensors 18 can be cross-checked with the specifications for each product 14. Additionally, given a known spacing between the sensors 18, the dimensions of each product 14 can be cross-checked with the number of sensors 18 actuated by the product 14. In either situation, if the sensed weight or number of sensors 18 indicate that the product 14 was not correctly identified by the unloading order, the control circuit 28, 32 can send an alert signal to a user smart device 44, such as a device of the associate unloading the delivery vehicle 38, to inform the user of the discrepancy. The user smart device 44 can be any suitable wireless communication device, such as a smartphone, tablet, and so forth.

In several embodiments, the control circuit 28, 32 can send the identification or general identification for each product 14 to the user smart device 44 prior to unloading or as each product 14 is being unloaded. The associate can cross-check the identification provided by the system during unloading to catch any errors in the identification of products 14. By another approach, the user can utilize the identification provided by the control circuit 28, 32 to choose a next product 14 to unload to thereby ensure that the product 14 matches the unloading order.

The system described herein can also advantageously be used to monitor and cross-check restocking locations for the products 14. More specifically, when products 14 are needed to restock product displays 46 at the front of a store 50, an associate can transport the storage structure 10 to areas at the front of the store 50 that require additional inventory. When a product 14, or portions thereof where a package contains multiple products, is removed from the storage structure 10, the sensors 18 will note the change, such as by complete removal of the product 14 or by a change of the weight thereof. For example, if an associate has to restock produce, the associate can transport the storage structure 10 to the produce section of the store 50, sequentially remove the produce from the product 14, and the sensors 18 will note the changes in weight of the product 14.

In order to cross-check that the products 14 are being stocked in the correct locations of the store 50, the system can further include one or more location determination devices 48 for the storage structure 10. When the control circuit 28 determines that the product 14 has been removed from the storage structure 10, or that the weight of the product 14 has decreased, the system can determine a current location of the storage structure 10 using the location determination devices 48. Next, the control circuit 28, 32 can access or receive store layout information, such as from one of the storage devices 24, 36, 40, that includes modular and product location information, and analyze the store layout information to determine where the product 14 is located within the store 50. The control circuit 28, 32 can then determine whether the current location of the storage structure 10 and the product location are within a predetermined proximity to one another, such as 5-15 feet, within the correct department or section of the store 50, or the like. The control circuit 28, 32 can further be configured to send an alert signal, such as to the user smart device 44, to notify the user in response to determining that the current location of the storage structure 10 is not in proximity to the product location.

The location determination devices 48 can take any suitable form. In one approach, the device 48 can be part of the electronic assembly 22 of the storage structure 10. The device 48 can utilize micro or geo-locationing. In another form, the device 48 can utilize beacon signals received from the product displays 46 or other structures within the store 50. In another form, the device 48 can utilize a non-visible modulation of lights within the store 50. In yet another form, the electronic assembly 22 can include global positioning system circuitry 48 so that the control circuit 28 can monitor the location of the storage structure 10. By another approach, the control circuit 32 can analyze images or video captured by electronic imagers 52, such as still or video cameras, or other locationing devices disposed within the store 50.

In some embodiments, a system for identifying and tracking a product during inventory processing is described herein that includes a movable product support structure having an upper surface configured to receive products thereon; an array of sensors mounted to the movable product support structure adjacent to the upper surface thereof and configured to actuate in response to a product being placed thereon; and a control circuit in communication with the array of sensors. The control circuit is configured to: access shipping information to determine an order and identification of products being placed on the product support structure; receive signals from one or more sensors of the array of sensors in response to a particular product being placed thereon; identify the particular product based on the shipping information; and associate a portion of the upper surface having the one or more sensors mounted thereto with the particular product.

By several approaches, the array of sensors can be an array of weight sensors each configured to determine a weight of a product placed thereon. By further approaches, the control circuit can be configured to track changes in a weight of the particular product using readings from the one or more sensors.

By some approaches, the system can further include a location tracking mechanism configured to track a location of the product support structure.

By several approaches, in response to determining a change in the weight of the particular product, the control circuit can be configured to access product display location information and compare the location of the product support structure at a time of the change in the weight to the product display location information to determine whether the particular product was stocked in a correct location.

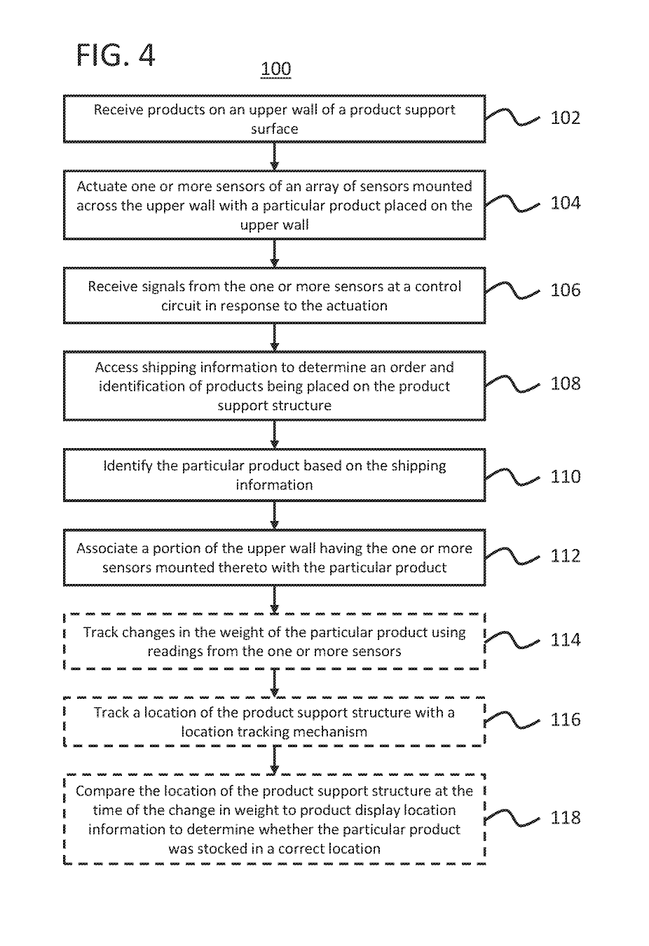

In several embodiments and as shown in FIG. 4, a method 100 for tracking products is described herein that includes receiving 102 products on an upper wall of a product support structure; actuating 104 one or more sensors of an array of sensors mounted across the upper wall with a particular product placed on the upper wall; receiving 106 signals from the one or more sensors at a control circuit in response to the actuation; accessing 108 shipping information with the control circuit to determine an order and identification of products being placed on the product support structure; identifying 110 the particular product based on the shipping information; and associating 112 a portion of the upper wall having the one or more sensors mounted thereto with the particular product with the control circuit.

By some approaches, actuating the one or more sensors can include actuating one or more weight sensors; and receiving the signals can include receiving a weight of the particular product placed thereon. By further approaches, the method 100 can further include tracking 114 changes in the weight of the particular product with the control circuit using readings from the one or more weight sensors.

By several approaches, the method 100 can further include tracking 116 a location of the product support structure with a location tracking mechanism.

By some approaches, the method 100 can further include accessing product display location information with the control circuit; and, in response to determining a change in the weight of the particular product, comparing 118 the location of the product support structure at a time of the change in the weight to the product display location information with the control circuit to determine whether the particular product was stocked in a correct location.

By several approaches, the method can further include creating a work task with the control circuit in response to determining that the particular product was not stocked in the correct location.

By some approaches, the method can further include resetting the array of sensors in response to an input.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for identifying and tracking a product during inventory processing in a retail facility, the system comprising:
a movable product support structure having an upper surface configured to receive products thereon;
an array of sensors mounted to the movable product support structure adjacent to the upper surface thereof and configured to actuate in response to a product being placed thereon; and
a control circuit in communication with the array of sensors, wherein the control circuit is configured to:
access shipping information to determine an order and identification of products being placed on the product support structure;
receive signals from one or more sensors of the array of sensors in response to a particular product being placed thereon;
identify the particular product based on the shipping information; and
associate a portion of the upper surface having the one or more sensors mounted thereto with the particular product.

2. The system of claim 1, wherein the array of sensors comprises an array of weight sensors each configured to determine a weight of a product placed thereon.

3. The system of claim 2, wherein the control circuit is further configured to track changes in a weight of the particular product using readings from the one or more sensors.

4. The system of claim 3, further comprising a location tracking mechanism configured to track a location of the product support structure.

5. The system of claim 4, wherein the location tracking mechanism comprises one or more camera devices in communication with the control circuit.

6. The system of claim 4, wherein, in response to determining a change in the weight of the particular product, the control circuit is further configured to access product display location information and compare the location of the product support structure at a time of the change in the weight to the product display location information to determine whether the particular product was stocked in a correct location.

7. The system of claim 6, wherein the control circuit is further configured to create a work task in response to determining that the particular product was not stocked in the correct location.

8. The system of claim 1, wherein the product support structure comprises a pallet.

9. The system of claim 1, wherein the product support structure comprises a cart.

10. A method for tracking products, the method comprising:
receiving products on an upper wall of a product support structure;
actuating one or more sensors of an array of sensors mounted across the upper wall with a particular product placed on the upper wall;
receiving signals from the one or more sensors at a control circuit in response to the actuation;
accessing shipping information with the control circuit to determine an order and identification of products being placed on the product support structure;
identifying the particular product based on the shipping information; and
associating a portion of the upper wall having the one or more sensors mounted thereto with the particular product with the control circuit.

11. The method of claim 10, wherein actuating the one or more sensors comprises actuating one or more weight sensors; and receiving the signals comprises receiving a weight of the particular product placed thereon.

12. The method of claim 11, further comprising tracking changes in the weight of the particular product with the control circuit using readings from the one or more weight sensors.

13. The method of claim 10, further comprising tracking a location of the product support structure with a location tracking mechanism.

14. The method of claim 13, further comprising:
accessing product display location information with the control circuit; and
in response to determining a change in the weight of the particular product, comparing the location of the product support structure at a time of the change in the weight to the product display location information with the control circuit to determine whether the particular product was stocked in a correct location.

15. The method of claim 14, further comprising creating a work task with the control circuit in response to determining that the particular product was not stocked in the correct location.

16. The method of claim 10, further comprising resetting the array of sensors in response to an input.
